(19) United States
(12) Patent Application Publication
(10) Pub. No.: US 2013/0038088 A1
(43) Pub. Date: Feb. 14, 2013

(54) VARAIBLE HEIGHT COMBAT VEHICLES

(71) Applicant: Amikran Shmargad, Foster City, CA (US)

(72) Inventor: Amikran Shmargad, Foster City, CA (US)

(21) Appl. No.: 13/548,830

(22) Filed: Jul. 13, 2012

Related U.S. Application Data
(60) Provisional application No. 61/507,467, filed on Jul. 13, 2011.

(51) Int. Cl. B62D 25/00; B23P 11/00

(52) U.S. Cl. 296/193.01; 29/897.2

(57) ABSTRACT

A vehicle system allowing for interchangeably attaching different shells to the hull of a vehicle chassis. The shells can be configured for different tasks allowing the vehicle to be easily configured for specific missions and then swapped for new shells based on changing mission requirements. The vehicle system attaches the shell to the support walls of the hull such that the hull can support the shell and withstand use of the equipment integrated into the shell.

### RELATED APPLICATION

The present application claims the benefit of U.S. Provisional Application No. 61/507,467, filed Jul. 13, 2011, which is incorporated herein in its entirety by reference.

### FIELD OF THE INVENTION

The present invention relates generally to combat vehicles. More specifically, it relates to configurable combat vehicles that utilize a common lower hull.

### BACKGROUND

Modern militaries utilize many different types of vehicles in order to accomplish specific tasks. In particular, non-turreted vehicles are often specially configured to address a specific need including weapons platform, troop transport, mobile medical stations or other necessary tasks. There are many challenges to implementing a fleet of military vehicles comprising many discrete, specialized vehicles. Such challenges include design and validation, transportation, and reconfiguration, among others.

Vehicle transportation itself poses significant obstacles to a military organization. Many transport vehicles, such as ships and aircraft, have cargo height restrictions. A vehicle taller than maximum cargo height of a preferred transportation vehicle must be transported by other means. Non-optimal vehicle transport can create substantial delays in mobilization time, which can compromise combat performance and increase transportation costs.

The disadvantages of traditional military combat vehicles do not end at the time of deployment. As missions progress, resource needs naturally evolve and change. For example, threats in a particular region may require a different vehicle structure. Reconfiguring the vehicle for a different task can require more than simply replacing the equipment mounted to the vehicle chassis. Certain configurations of the vehicle can require more robust or specialized means of attaching the equipment or housing. For example, configuring a vehicle to be mobile weapons platform can require specialized mounting of the weapons to account for the forces created from firing the weapon. Traditional military combat vehicles are not readily adaptable to a wide variety of configurations without requiring major redesign and remanufacturing undertakings for each reconfiguration. Similarly, modifying a vehicle for a particular configuration can may returning the vehicle to a prior configuration more arduous and also require substantial remanufacturing of the vehicle.

Certain prior art references disclose configurable body and chassis systems; however, no such systems provide for fast and easy configurability that is sufficiently durable for military combat applications. U.S. Patent Application 2006/0237239A1, for example, discloses a personal utility vehicle with a quick-change body. While the quick-change body is convenient for personal or recreational use, the body-to-chassis coupling means is neither sufficiently accessible nor durable for military applications.

Automotive passenger car manufacturers commonly utilize common chassis and vehicle platforms for a plurality of vehicle models. While this type of universal chassis provides many advantages over conventional vehicle chassis, it does not allow for convenient reconfiguration once the vehicle is manufactured. Substantial time and effort is needed for one to remove the original body from the chassis and attach another body thereto.

A ride-height control system for trucks and other heavy-duty vehicles is disclosed in U.S. Patent Application 2009/0033044A1. Systems such as this are utilized, for example, to maintain a constant ride height while cargo is loaded or unloaded, or to avoid tall obstacles. While these advantages are noteworthy for particular applications, the limited range of such systems fails to provide a solution to cargo height restrictions with respect to the transport of many tall military vehicles.

What is needed is a military vehicle that utilizes a common lower hull portion, to which various shells can be attached in order to optimally configure the vehicle for specific mission requirements. The hull and shell must be quickly, yet rigidly attached, to allow for quick reconfiguration on a battlefield. Moreover, the attachment means must account for the particular structural needs of the shell and the equipment used to reconfigure the vehicle. In addition to being quickly reconfigured, the attachment means must be easily disassembled for returning the vehicle to a prior configuration. Furthermore, the hull and shell must be able to be transported independent from one another.

### SUMMARY OF THE INVENTION

The present invention is intended to provide an improved military combat vehicle that is capable of being easily and quickly reconfigured to the optimal vehicle configuration for a given mission role. The present invention comprises a common lower hull to which various shells can be attached. The common lower hull provides a universal interface that can be affixed to a corresponding interface on each shell. The universal interface aligns the shell with the existing structural framework such that the assembled hull and shell will function as a monolithic structure. By integrating the shell into the hull rather than simply bolting on the shell and equipment, the arrangement reduces the likelihood that use of the equipment will separate the shell from the hull or otherwise damage the assembly. This provides significant improvements over existing technology, including but not limited to improvements in combat reconfiguration and adaptability, transportability, cost, and durability.

The common hull of the present invention provides a single complete chassis that can be utilized by a wide range of vehicle configurations. The hull comprises the entire vehicle frame, which is designed to provide optimal structural strength for a wide range of vehicle variants. Mission equipment package units or shell can be tailored to perform various and changing missions. Variants of the present invention include but are not limited to (a) medical treatment vehicles; (b) medical evacuation vehicles; (c) command posts; (d) mortar vehicles; and (d) general purpose vehicles.

A common hull, according to an embodiment of the present invention, comprises a rim positioned on a top portion of the hull. Each shell comprises a corresponding rim engagable to the rim of the common hull. Although each shell can have varied equipment or shape, the corresponding rim of each shell is substantially the same shape and dimensions as the rim of the hull. A substantial portion of the rim of the hull is positioned on at least one structural wall of the hull. In this configuration, the weight of the shell and any forces or stresses created from using the equipment in the shell is translated through the interfaced rims into the structural walls of the hull. In one aspect, the rim of the hull can define a continuous ring on the top portion of the hull. In this configuration, the rim can support the shell continuously along the periphery of the shell to prevent shearing or shifting of the shell. In one aspect, the rim of the shell can be positioned beneath the outer wall of the shell such that aligning the rims will align the outer wall of the shell with the structural walls of the hull.

The rims of the hull and shell each have a plurality of corresponding mounting features that can be aligned and secured together to secure the hull and shell together. The mounting features of the rims can be securely coupled by utilizing bolts or other fasteners to secure the corresponding mounting features together. The mounting features are defined along the periphery of the rims to affix the shell to the hull such that the assembled shell and hull are effectively a monolithic structure. The fastener can be removed from the mounting features to separate the shell from the hull and reconfigure the vehicle for a different mission.

In an embodiment of the present invention, the mounting features can each comprises a bolt hole through the corresponding rim. The fastener can comprise a bolt insertable through the corresponding bolt holes to fasten the rims together in order to secure the hull to the shell. In one aspect, the bolt can be selected to account for the type of hull to be affixed to the shell or the equipment used in the configuration. In one aspect, a heavier bolt can be used to retain a heavier hull or to withstand the forces generated by a weapons platform.

Traditional military vehicles have to undergo an extensive remanufacturing process that involved cutting and re-welding the vehicle structure in order to reconfigure a vehicle for a different task. These processes were inherently destructive in nature and could potentially compromise the vehicle's structural integrity. The reconfiguration process of the present invention is entirely nondestructive, so that the vehicle can undergo multiple reconfigurations without damaging either the hull or shells. Furthermore, the reconfiguration process requires standard tools and can be completed much faster than traditional vehicle reconfiguration means.

The present invention also provides a number of logistical efficiencies as compared to traditional military vehicle usage. Such logistical efficiencies correspondingly result in reducing cost, increasing military response time, and optimizing combat resources, all of which are top priorities of militaries.

The present invention provides significant improvements in military vehicle transportation. Military transport vehicles can typically accommodate cargo up to a given height. Accordingly, militaries often must use alternate transportation means to transport vehicles above such height restrictions, which results in longer transport times and increased expense. Because the present invention allows for vehicle hulls and shells to be attached and removed with minimal effort, they can be shipped in their disassembled state and easily assembled upon arrival. Significantly, vehicles that were once unable to be transported in a given transport vehicle because they were too tall will now be able to be transported in their disassembled state.

Another advantage of the present invention is that less total vehicles will have to be transported for a given mission. Inevitably, missions evolve and requirements change over time. Instead of transporting every vehicle type that is required to carry out a given mission, a military utilizing the present invention only has to transport the maximum number of hulls that will be needed at any given time, and any shells that will be needed over a given timeframe. Accordingly, a military can transfer fewer hulls than total vehicles. Instead of entire vehicles sitting idle when unused, only vehicle shells will remain unused depending on specific mission needs.

As expected, the common hull design of the present invention provides significant engineering and manufacturing advantages over traditional military vehicle design. Engineering design and validation is expensive and time consuming. By utilizing a common hull, this part has to be designed and validated only once. Vehicle shells can be designed and validated independently from, and in parallel to the hull, which significantly cuts development time and cost.

Further, the common hull design of the present invention provides manufacturing advantages over traditional military vehicle manufacturing. A common hull can be manufactured in large quantities on dedicated manufacturing lines, which decreases capital expenditure and set-up time. Furthermore, since higher quantities of a single design will be manufactured, raw components will be available for lower cost due to economies of scale.

Utilization of a common hull or chassis provides a number of structural challenges as compared to the welded one piece design typical of military vehicles. The present invention incorporates a design that provides structural integrity for low back (LB), middle back (MB) and high back (HB) designs of top or upper hulls. The present invention satisfies the structural demands of the critical interface region between the upper hull and the lower chassis. Analysis of the bolt strength, bolt placement, hull stiffness, non-coplanar surface tolerance mating for flanges and other operative loads were conducted. The present invention satisfied the structural requirements for the common chassis under the following load cases: 10 G vertical down; +/−8 G longitudinal & 1 G gravity; +/−5 G lateral & 1 G gravity; Racking load by applying 1.5 GVW vertically at the sprockets; Non-coplanar surfaces for mating flanges at maximal machine tolerance; Mil-Std-209K equal sling lifting; and Blast loading. In an exemplary embodiment it is recommended to use bolt size to ⅝ inch dia., 11UNC Grade 8 when mounting the variable top. The tolerance for the mating surface should be preferably within 0.005 inch/ft. To simplify and strengthen the concept, the front edge of the interface should be straight, eliminating the small jog toward the driver hatch. The flange of the bolted joint may be designed to include a shear lip or ramp that positively locates the mating surfaces and takes the shear loads.

### BRIEF DESCRIPTION OF THE DRAWINGS

FIG. 1 is an exploded view of an embodiment of the vehicle of the present invention;

FIG. 2 is a view of a hull according to an embodiment of the present invention, illustrating the top rim and bolt pattern; and

FIG. 3 is an exploded view of an embodiment of the vehicle of the present invention, illustrating two possible variants: a mid-back shell variant is shown in wireframe and a high-back shell variant is shown as a solid.

FIG. 4 are perspective views of the different variants of the upper hull designs.

FIG. 5 is a partial cross-sectional side view of engaging a shell to a hull through a bolt inserted through two corresponding fastening means.

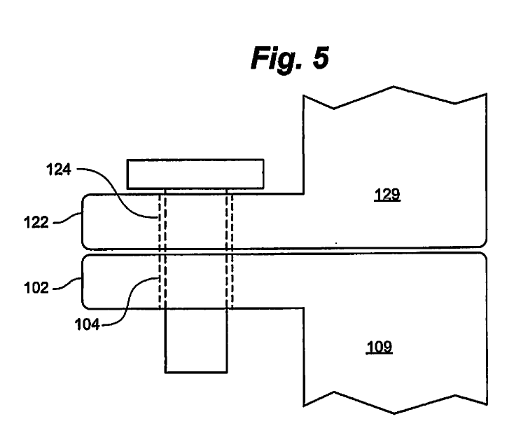

While the present invention is amenable to various modifications and alternative forms, specifics thereof have been shown by way of example in the drawings and will be described in detail. It should be understood, however, that the intention is not to limit the present invention to the particular embodiments described. On the contrary, the intention is to cover all modifications, equivalents, and alternatives falling within the spirit and scope of the present invention.

### DETAILED DESCRIPTION OF THE DRAWINGS

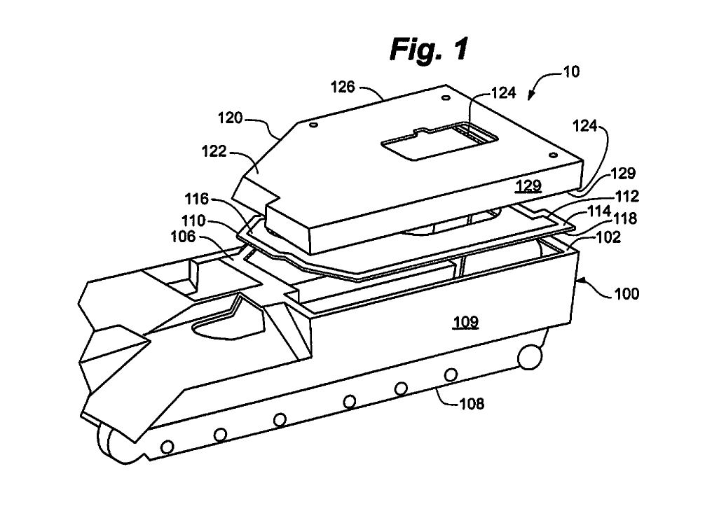

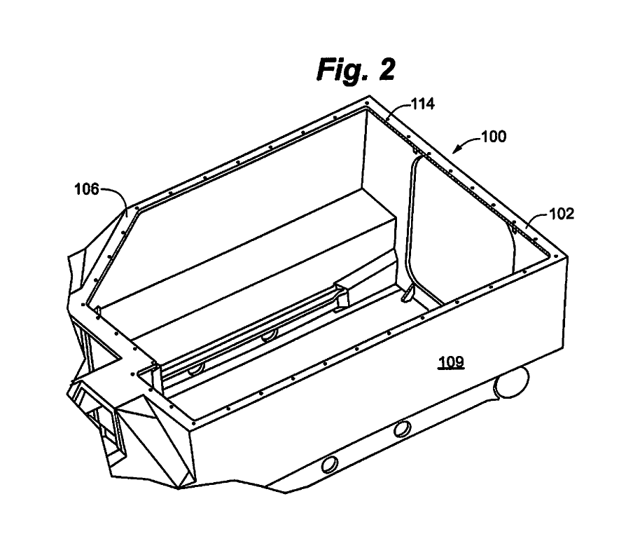

FIG. 1 depicts a vehicle 10 in accordance with an embodiment of the present invention which broadly includes a lower hull 100 having a top side 106 and a bottom side 108. The hull 100 can further comprise at least one structural wall 109 for maintain the shape of the vehicle 10. Top side 106 comprises lower hull rim 102 positioned on the top side 106 of the lower hull 100 and includes a plurality of fastening members 104 (see FIG. 2). As shown in FIG. 1, a substantial portion of the hull rim 102 can be positioned over a structural wall 109 such that any forces acting on the hull rim 102 will be directed into the structural wall 109.

A top plate 110 is utilized in certain embodiments in which additional armor is required. Top plate 110 has a top side 116 and a bottom side 118. A top plate rim 112 is located along the outer edge of top plate 110, on both top side 116 and bottom side 118, and is substantially equivalent in dimension to lower hull rim 102. Top plate rim 112 further includes fastening members 114 which are substantially coaxial to lower hull fastening members 104 when lower hull 100 and top plate 110 are assembled. In one aspect, the hull rim 102 can define a continuous ring such that the hull rim 102 and the corresponding structural walls 109 beneath the rim 102 provide continuous support for the top plate 110 along the entire periphery of the top plate 110.

A mid-back shell 120 is utilized in certain embodiments of the present invention. Mid-back shell 120 has a top side 126 and a bottom side 128. Mid-back shell rim 122 is located along the outer edge of the bottom side 128 of mid-back shell 120. As with top plate rim 112, mid-back shell rim 122 is dimensioned substantially equivalent to lower hull rim 102. In one aspect, the shell 120 can further comprise an outer wall 129 wherein the shell rim 122 is positioned beneath the outer wall 129. In this configuration, the outer wall 129 aligns with the structural wall 109 when the shell rim 122 is aligned with the hull rim 102 to present a continuous wall surface between the hull 100 and the shell 120. In one aspect, protruding portions of the outwall 129 in conventional shells 120 can be modified such that the out wall 129 aligns with the corresponding structural wall 109 continuously along the periphery of the shell 120. Mid-back shell rim 122 further includes fastening members 124 which are substantially coaxial to lower hull rim fastening members 104 when lower hull 100 and mid-back shell 120 are assembled.

FIG. 2 depicts lower hull 100, which includes a plurality of fastening members 104. In one aspect, the fastening members 104, 114, 124 can comprise bore holes through which a bolt can be inserted to affix the hull 100, the top plate 110 and the shell 120 together. Fastening members 104 are spaced along the hull rim 102 in a fixed pattern which matches the fastening member 114, 124 pattern of any attachment, such as that of top plate 110 or mid-back shell 120, among others. The fastening members 104, 114, 124 are positioned along the entire periphery of the rim 102, 112, 122 such that engaging the fastening members 104, 114, 124 together affixes the hull 100, the top plate 110 and the shell 120 into a continuous monolithic structure. Similarly, the hull rim 102 can define a continuous ring allow engagement of the top plate 110 and the shell 120 to the hull 100 along the entire periphery of the rim 102. Referring back to FIG. 1, vehicle 10 according to an embodiment of the present invention, is assembled by mating the bottom side 118 of top plate 110 to top side 106 of lower hull 100, and mating the bottom side 128 of mid-back shell 120 to top side 116 of top plate 110, so that fastening members 104, 114, and 124, respectively, are substantially coaxial. Lower hull 100, plate 110, and mid-back shell 120 are then rigidly, yet removably coupled by fastening bolts through each of the plurality of bolt holes comprising bolt holes of the fastening members 104, 114, and 124, respectively, with plate 110 sandwiched between lower hull 100 and mid-back shell 120.

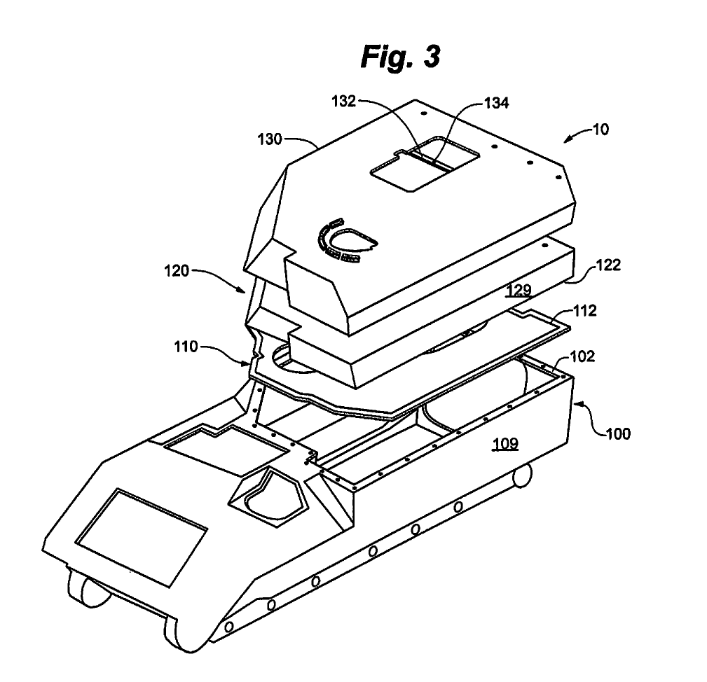

FIG. 3 depicts an embodiment of the present invention, showing common lower hull 100, to which top plate 110, mid-back shell 120, or high-back shell 130 may be coupled. High-back shell 130 may be utilized in certain embodiments instead of mid-back shell 120 if, for example, a higher ride height is desired for a certain mission. Depending on the desired configuration, top plate 110 may be utilized in conjunction with mid-back shell 120 or high-back shell 130. High-back shell 130 comprises rim 132 and bolt holes 134, which are substantially equivalent in nature to the corresponding components of mid-back shell 120. High-back shell 130 assembles to lower hull 100 in substantially the same manner as mid-back shell 120 assembles to lower hull 100.

As shown in FIG. 3, in operation, a vehicle 10, can be assembled by providing a hull 100 having a rim 102 positioned over at least one structural wall 109 of the hull 100, wherein the rim 102 comprises a first plurality of fastening members 104 spaced along the length of the rim 102. An appropriate shell 120 having a rim 122 positioned on the bottom side 128 of the shell 120 is selected for a desired configuration of the vehicle 10, wherein the rim 122 also comprises a second plurality of fastening members 124 corresponding to the first plurality of fastening members 104 of the hull rim 102. The shell 120 is positioned over the hull 100 such that the corresponding fastening members 104, 124 of the rims 102 and 122 are aligned, before the shell 120 is lowered onto the hull 100. A bolt is then inserted through each of the corresponding pairs of fastening members 104, 124 to affix the shell 120 to the hull 100. In one aspect, a top plate 110 having a rim 112 with a plurality of fastening members 114 can be inserted between the hull 100 and the shell 120 such that the fastening members 114 align with corresponding fastening members 104, 114 of the hull 100 and the shell 120. In this configuration, the bolt is then inserted through all of the corresponding fastening members 104, 114, 124 to affix the assembly together.

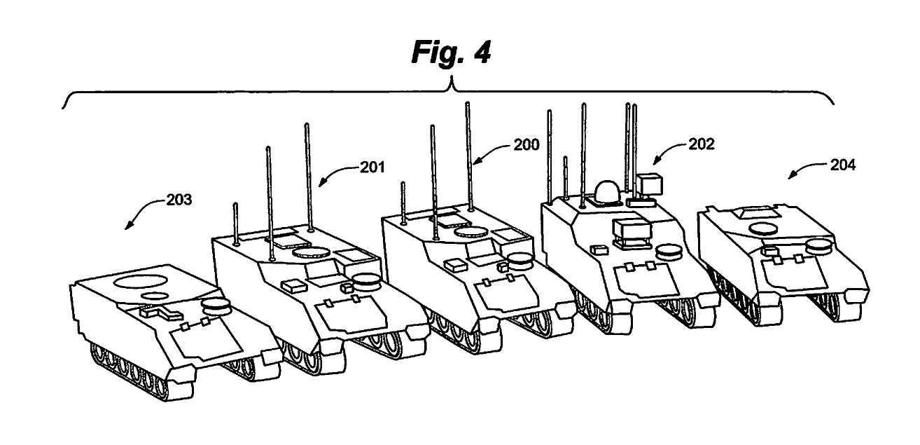

As shown in FIGS. 3-4, the shell 120 can be removed from the hull 100 by removing the plurality of bolts from the fastening members 104, 114, thereby allowing the shell 120 to be removed from the hull 100. The shell 120 can be replaced by selecting a different shell 120 configured for a different task including, but not limited to, medical treatment, medical evacuation, command equipment and a mortar platform. As with the first shell 120, the second shell 120 is attached by aligning the rim 122 of the shell 120 with the rim 102 of the hull 100 before inserting a bolt through the aligned fastening members 104, 114.

FIG. 4 depicts the various embodiments of mission equipment packages have top hull designs including medical treatment vehicles 200; medical evacuation vehicles 201; command posts 202; mortar vehicles 203; and general purpose vehicles 204. As depicted, the range of low back (LB), middle back (MB) and high back (HB) designs of top or upper hulls are shown. In all of these configurations, the rim 122 of the corresponding shell 120 comprises the same shape and dimensions such that all of the shells 120 can interface with the same hull rim 102 without substantial modification of the hull 100.

The embodiments above are intended to be illustrative and not limiting. Additional embodiments may be within the claims. Although the present invention has been described with reference to particular embodiments, workers skilled in the art will recognize that changes may be made in form and detail without departing from the spirit and scope of the invention.

Various modifications to the invention may be apparent to one of skill in the art upon reading this disclosure. For example, persons of ordinary skill in the relevant art will recognize that the various features described for the different embodiments of the invention can be suitably combined, un-combined, and re-combined with other features, alone, or in different combinations, within the spirit of the invention. Likewise, the various features described above should all be regarded as example embodiments, rather than limitations to the scope or spirit of the invention. Therefore, the above is not contemplated to limit the scope of the present invention.

1. An integrated combat vehicle system for performing multiple missions, said combat vehicle system comprising a common hull portion and an interchangeable mission equipment package unit, wherein said common hull portion includes a drive system and a universal lower hull payload area, said common hull portion having a mating surface to which the mission equipment package unit may be attached.

2. The integrated combat vehicle system of claim 1 wherein the mission equipment package unit contains a mounting rim.

3. The integrated combat vehicle system of claim 2 wherein the mounting rim is a flange disposed toward the interior of the mission equipment package unit.

4. The integrated combat vehicle system of claim 1 wherein the mission equipment package unit is for a medical treatment vehicle.

5. The integrated combat vehicle system of claim 1 wherein the mission equipment package unit is for a medical evacuation vehicle.

6. The integrated combat vehicle system of claim 1 wherein the mission equipment package unit is for a command post vehicle.

7. The integrated combat vehicle system of claim 1 wherein the mission equipment package unit is for a mortar vehicle.

8. The integrated combat vehicle system of claim 1 wherein the mission equipment package unit is for a general purpose vehicle.

9. The integrated combat vehicle system of claim 1 wherein the common hull portion includes a driver's position and hatch.

10. The integrated combat vehicle system of claim 9 wherein the mission equipment package unit is sized so as to not block the driver's position and hatch of the common hull portion.

11. The integrated combat vehicle system of claim 2 wherein the mating surface of the common hull portion is disposed to match the mounting rim of the mission equipment package unit about the periphery of the respective units.

12. The integrated combat vehicle system of claim 11 wherein the mating surface of the common hull portion includes a flange, said flange includes a shear lip or ramp that positively locates the mounting rim of the mission equipment package unit and takes the shear loads.

13. The integrated combat vehicle system of claim 11 wherein bolts are used to fasten the mission equipment package unit to the common hull portion.

14. A method of configuring a combat vehicle, the method comprising:
selecting a shell portion depending on the requirements of a specific mission; and
assembling the shell portion to a common hull portion of the combat vehicle.

15. A method of re-configuring a combat vehicle, the method comprising:
removing a first shell portion from a combat vehicle;
selecting a second shell portion depending on the requirements of a specific mission; and
assembling the second shell portion to the common hull portion of the combat vehicle.

16. A method of re-configuring a combat vehicle, the method comprising:
providing a hull having a hull rim positioned over at least one structural wall of the hull, wherein the hull rim comprises a first plurality of fastening members;
providing a plurality of shells each having a shell rim sized to correspond to the hull rim, wherein the shell rim of each shell comprises a second plurality of fastening members;
aligning the shell rim of a first shell with the hull rim such that each of the first plurality of fastening members aligns with at least one of the second plurality of fastening members; and
inserting at least one bolt through each of the aligned first fastening member and second fastening members to engage the hull to the first shell.

17. The method of reconfiguring a combat vehicle in claim 16, further comprising:
removing the bolt from each aligned first fastening member and second fastening member to disengage the hull from the first shell;
lifting the first shell off the hull;
selecting a second shell of the plurality of shells;
aligning the shell rim of a second shell with the hull rim such that each of the first plurality of fastening members aligns with at least one of the second plurality of fastening members; and
inserting at least one bolt through each of the aligned first fastening member and second fastening members to engage the hull to the first shell.
